(19) United States
(12) Patent Application Publication
(10) Pub. No.: US 2020/0313586 A1
(43) Pub. Date: Oct. 1, 2020

(54) METHOD OF CONTROLLING CURRENT IN AN INTERIOR PERMANENT MAGNET MOTOR WITH THERMAL ADAPTATION AND POWERTRAIN WITH SAME

(71) Applicant: GM Global Technology Operations LLC, Detroit, MI (US)

(72) Inventors: Suresh Gopalakrishnan, Troy, MI (US); Anno Yoo, Rochester, MI (US); Wesley G. Zanardelli, Rochester, MI (US); Yo Chan Son, Rochester Hills, MI (US)

(73) Assignee: GM Global Technology Operations LLC, Detroit, MI (US)

(21) Appl. No.: 16/364,893

(22) Filed: Mar. 26, 2019

(51) Int. Cl. H02P 21/00; H02P 21/14; H02P 21/16; H02P 21/18; H02P 21/22; B60K 6/26; B60K 6/28; B60L 50/60; B60L 15/00; B60W 20/00

(52) U.S. Cl. CPC H02P 21/001; B60Y 2200/92; H02P 21/141; H02P 21/16; H02P 21/18; H02P 21/22; B60K 6/26; B60K 6/28; B60L 50/60; B60L 15/00; B60W 20/00; H02P 2207/05; B60L 2240/421; B60L 2240/425; B60L 2240/429; B60Y 2200/91; H02P 21/0025

(57) ABSTRACT

A method of controlling an interior permanent magnet (IPM) motor includes receiving a motor torque command, and selecting a nominal d-axis current and a nominal q-axis current stored in a first lookup table. The nominal d-axis current and the nominal q-axis current correspond with a predetermined efficiency of the IPM motor at a nominal temperature and are based on at least the motor torque command and magnetic flux at a nominal temperature of the IPM motor. A d-axis adjustment current and a q-axis adjustment current are then selected from a stored second lookup table. The adjustment currents correspond with the predetermined efficiency of the IPM motor and are based at least on the magnetic flux and an operating temperature of the IPM motor. A corrected d-axis current and a corrected q-axis current are commanded. The corrected currents are the sum of the respective nominal current and adjustment current.

Torque control systems for electric machines, such as interior permanent magnet motors, are often configured to control the motor without considering the effect of motor temperature on the controlled parameters. Stated differently, these motor control systems treat the motor temperature as if it is an unvarying temperature as determined by the motor cooling system, e.g., 90 degrees Celsius. Additionally, in some applications in which an interior permanent magnet motor may be used, such as a battery electric vehicle or a hybrid electric vehicle, it may take a significant amount of time before the motor temperature reaches the temperature for which the motor cooling system is set.

### SUMMARY

The magnetic flux density of permanent magnets is temperature dependent. Accordingly, the torque output of an interior permanent magnet motor is best controlled if the temperature of the permanent magnets is accounted for. The current commanded affects the energy efficiency of the powertrain system that includes the motor. For optimal energy efficiency, motors may be controlled to function along a maximum torque per ampere trajectory at relatively low rotor speeds, and along a maximum voltage per ampere trajectory at relatively high rotor speeds.

An interior permanent magnet motor and a method of controlling an interior permanent magnet motor disclosed herein enables accurate torque control without compromising energy efficiency. The method of controlling an interior permanent magnet motor comprises receiving a motor torque command, and selecting, via a controller, a nominal d-axis current and a nominal q-axis current from a first lookup table stored in the memory of the controller. The nominal d-axis current and the nominal q-axis current correspond with a predetermined efficiency of the interior permanent magnet motor at a nominal temperature of the interior permanent magnet motor and are based on the motor torque command and a magnetic flux at the nominal temperature of the interior permanent magnet motor. The method then includes selecting, via the controller, a d-axis adjustment current and a q-axis adjustment current stored in a second lookup table in the memory of the controller, the d-axis adjustment current and the q-axis adjustment current corresponding with the predetermined efficiency of the interior permanent magnet motor and based at least on the magnetic flux and an operating temperature of the interior permanent magnet motor. The method then includes commanding, via the controller, a corrected d-axis current and a corrected q-axis current. The corrected d-axis current is a sum of the nominal d-axis current and the d-axis adjustment current, and the corrected q-axis current is a sum of the nominal q-axis current and the q-axis adjustment current.

In some embodiments of the method, the current adjustments are determined and corrected currents are commanded only when the rotor speed is less than or equal to a base rotor speed (e.g., only for operation in the constant torque region of the Torque-speed plot of the electric machine). In other embodiments, the current adjustments are determined and corrected currents are commanded at all operating speeds (e.g., regardless of operating speed).

The above features and advantages and other features and advantages of the present disclosure are readily apparent from the following detailed description of the best modes for carrying out the disclosure when taken in connection with the accompanying drawings.

### BRIEF DESCRIPTION OF THE DRAWINGS

FIG. 1 is a vehicle with a hybrid powertrain including an interior permanent magnet motor.

FIG. 2 is a vehicle with an all-electric powertrain including an interior permanent magnet motor.

FIG. 3 is a schematic illustration of an interior permanent magnet motor.

FIG. 4 is a schematic illustration of one pole of the interior permanent magnet motor.

FIG. 5 is a plot of torque in Newton-meters versus rotational speed in revolutions per minute of the rotor of the interior permanent magnet motor.

FIG. 6 is a plot of q-axis current versus d-axis current, showing constant torque ellipses, an inverter current limit, and optimal efficiency of maximum torque per ampere trajectories at three different temperatures of the interior permanent magnets of the interior permanent magnet motor.

FIG. 7 is a portion of the plot of FIG. 6 illustrating the differences in d-axis current and q-axis current for operation of the interior permanent magnet motor at two different temperatures of the interior permanent magnets and at a given torque and rotational speed.

FIG. 8A is a first portion of a flow diagram of a method of controlling the interior permanent magnet motor.

FIG. 8B is a second portion of the flow diagram of FIG. 8A

FIG. 9 is a schematic depiction of a portion of the method of FIGS. 8A-8B.

FIG. 10 is a plot of q-axis current versus d-axis current, with constant torque ellipses, and optimal efficiency trajectories for all rotational speeds and at two different temperatures of the interior permanent magnets of the interior permanent magnet motor.

FIG. 11 is a portion of the plot of FIG. 10 illustrating the differences in d-axis current and q-axis current for operation of the interior permanent magnet motor at two different temperatures of the interior permanent magnets and at given torque and rotational speeds.

FIG. 12 is a flow diagram of another method of controlling the interior permanent magnet motor.

FIG. 13 is a schematic depiction of a portion of the method of FIG. 12.

### DETAILED DESCRIPTION

Efficient operation of an interior permanent magnet motor accounts for the effect of temperature on the torque output of the motor, and includes selecting to operate according to a maximum torque per ampere (MTPA) current trajectory when rotor speeds are at or below a base speed, and toward the a maximum torque per voltage (MTPV) trajectory at speeds higher than the base speed.

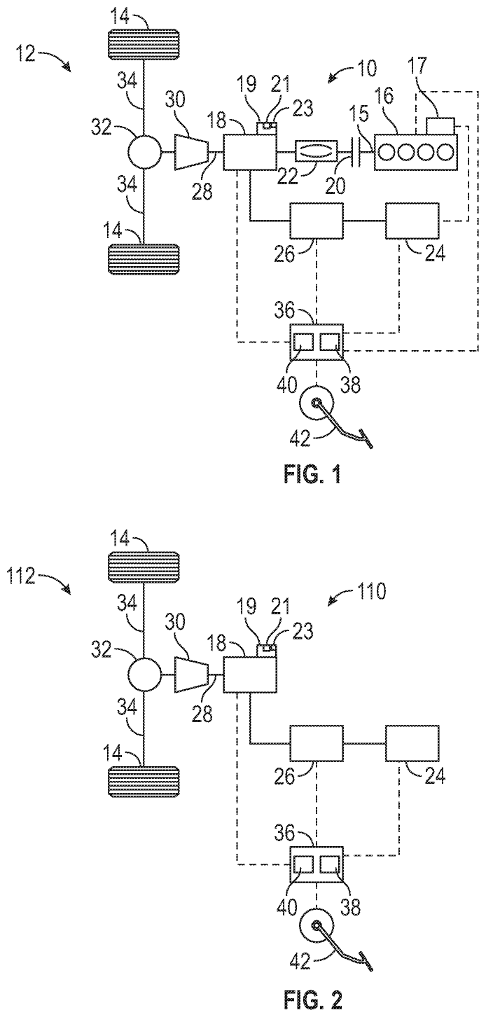

Referring to the drawings, wherein like reference numbers refer to like components, FIGS. 1 and 2 depict powertrains that include electric machines that are interior permanent magnet motors, and the control of which can be optimized according to the methods disclosed herein to adjust the current provided to the electric machine to account for the effect of temperature on the torque output of the motor.

FIG. 1 schematically depicts a hybrid powertrain 10 included on a vehicle 12 for providing propulsion torque to vehicle wheels 14. The hybrid powertrain 10 has both a petrol propulsion source, such as an internal combustion engine 16, and an electric propulsion source, such as an electric machine 18 that is an interior permanent magnet motor and may be referred to as such. Either or both of the propulsion sources may be selectively activated to provide propulsion based on the vehicle operating conditions. The hybrid powertrain 10 is shown on a vehicle, but may be used on many different devices configured to receive rotary torque and which employ a feed-forward control system. The internal combustion engine 16 operates as the petrol propulsion source and outputs torque to a shaft 15. The engine 16 may have a plurality of cylinders to generate power from the combustion of a fuel to cause rotation of the shaft 15. A starter motor 17 is configured to start (e.g., crank) the engine 16, and may be powered by the same or a different energy storage device 24 as used to power the electric machine 18. The energy storage device 24 may be one or more interconnected batteries, and may be referred to herein as battery 24.

One or more decoupling mechanisms may be included in order to decouple output of engine 16 from the remaining portions of the powertrain. A clutch 20 may be provided to allow selection of a partial or complete torque decoupling of the engine 16. A torque converter 22 may also be included to provide a fluid coupling between the output portion of engine 16 and downstream portions of the powertrain 10.

The electric machine 18 operates as the electric propulsion source and is powered by an energy storage device 24, such as a relatively high-voltage traction battery. High-voltage direct current from the energy storage device 24 is conditioned by an inverter 26 before delivery to the electric machine 18. The inverter 26 includes a number of switches controllable to convert the direct current into three-phase alternating current to drive the electric machine 18.

The electric machine 18 has multiple operating modes depending on the direction of power flow. In a motor mode, power delivered from energy storage device 24 allows the electric machine 18 to operate as a motor to output torque to shaft 28. The output torque may then be transferred through a variable ratio transmission 30 to change the gear ratio prior to delivery to a final drive mechanism 32. In one example the final drive mechanism 32 is a differential configured to distribute torque to one or more shafts 34 which are coupled to the wheels 14. The electric machine 18 may be disposed either upstream of the transmission 30, downstream of the transmission 30, or integrated within a housing of the transmission 30.

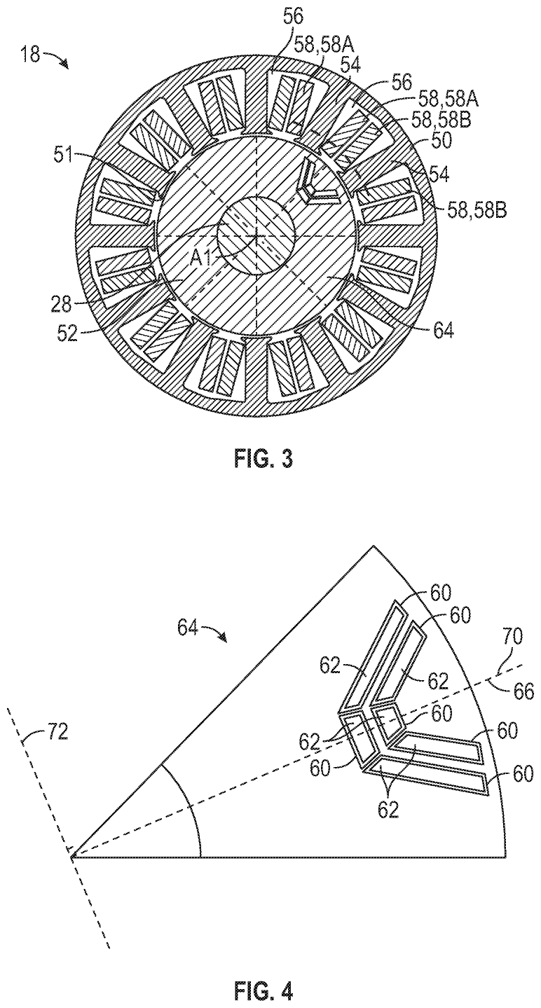

The electric machine 18 is also configured to operate in a generator mode to convert rotational motion into electric power to be stored in the energy storage device 24. When the vehicle 12 is moving, whether propelled by the engine 16 or coasting from its own inertia, rotation of shaft 28 turns a rotor (shown in FIG. 3) of the electric machine 18. The motion causes an electromagnetic field to generate alternating current that is passed through the inverter 26 for conversion into direct current. The direct current may then be provided to the energy storage device 24 to replenish the charge stored in the energy storage device 24. A unidirectional or bidirectional DC-DC converter (not shown) may be used to charge a relatively low-voltage battery (not shown) that is used to power the starter motor 17 and supply low voltage loads such as 12-volt loads.

The various powertrain components discussed herein may have one or more associated controllers to control and monitor operation. Controller 36, although schematically depicted as a single controller, may be implemented as one controller, or as a system of controllers in cooperation to collectively manage the powertrain 10. Multiple controllers may be in communication via a serial bus (e.g., Controller Area Network (CAN)) or via discrete conductors. The controller 36 includes one or more digital computers each having a microprocessor or central processing unit (CPU), referred to herein as a processor 38, and memory 40, such as read only memory (ROM), random access memory (RAM), electrically-programmable read only memory (EPROM), a high speed clock, analog-to-digital (A/D) and digital-to-analog (D/A) circuitry, input/output circuitry and devices (I/O), as well as appropriate signal conditioning and buffering circuitry. The processor 38 may include stored, computer executable instructions that, when executed, cause the controller 36 to perform actions and issue commands that control the interior permanent magnet motor 18 according to the methods disclosed in the present disclosure.

For example, the controller 36 is programmed to coordinate operation of the various propulsion system components. The controller 36 is in communication with the engine 16 and receives signals indicative of engine speed and other engine operating conditions. The controller 36 is also in communication with the interior permanent magnet motor 18 and receives signals indicative of and/or via which operating parameters are determined, such as rotor speed, torque, current draw (operating d-axis and q-axis currents), magnetic flux, operating temperature of permanent magnets included in the motor, etc. The signals may be from various sensors and the operating parameters may be determined or estimated from the signals. The controller 36 may also be in communication with the energy storage device 24 and receive signals indicative of at least battery state of charge (SOC), temperature, and current draw.

The controller 36 may further be in communication with a driver input device 42 which may be a foot pedal, as depicted, a joy stick, such as a hand-operated input mechanism, or another mechanism. Sensors such as a position sensor operatively connected to the driver input device 42 may be in communication with the controller 36 so that the controller 36 receives signals indicative of pedal position which may reflect an acceleration request of the driver. The driver input device 42 may include an accelerator pedal and/or a brake pedal. If the vehicle 12 is a self-driving autonomous vehicle, acceleration demand may instead be determined by a computer either on-board or off-board of the vehicle without driver interaction, which is then converted into a torque request received by the controller 36. The controller 36 may be configured to convert the torque request into a torque command of one or both of the engine 16 and the electric machine 18, and then to control the powertrain 10, including the electric machine 18 to provide the commanded torque.

FIG. 2 shows an embodiment of an alternative powertrain 110 included on a vehicle 112. The powertrain 110 has many of the same components as described with respect to powertrain 10 and vehicle 12, and these are numbered identically as in FIG. 1. The powertrain 110 has one or more electric propulsion sources, such as electric machine 18 powered by one or more batteries as the energy storage device 24, and no engine, fuel cell, or other propulsion source. Accordingly, the powertrain 110 is an electric powertrain and not a hybrid powertrain, and the vehicle 112 may thus be referred to as an electric vehicle, an all-electric vehicle, or a battery electric vehicle.

FIG. 3 shows the electric machine 18 configured as an interior permanent magnet motor 18 that includes a stator 50 and a rotor 52. An air gap 51 is formed between an outer peripheral surface of the rotor 52 and an inner peripheral surface of the stator 50. The interior permanent magnet motor 18 is one representative example and other embodiments may be used within the scope of the disclosure. The stator 50 includes a plurality of teeth 54 arranged radially about an inner circumference of the stator 50. The teeth 54 define slots 56 between two adjacent teeth. The slots 56 provide space for conducting coils 58 (also referred to as electrical windings) to be wound around the teeth 54. Dashed lines are shown on two of the windings 58A, 58B, to show a path of each of the windings around the respective tooth 54. The controller 36 is operatively connected to the electrical windings 58, such as via the inverter 26 and can command the energy storage device 24 and the inverter 26 to operate to energize the stator 50 to drive the rotor 52.

The rotor 52 includes a plurality of steel laminations assembled onto the shaft 28, wherein the shaft 28 defines a longitudinal axis A1. Each of the steel laminations includes a plurality of pole portions 64 and each of the pole portions 64 includes a plurality of slots 60 disposed near an outer periphery. The slots 60 of the steel laminations are longitudinally aligned. There may be multiple layers of slots 60 at each pole portion 64, or only one layer.

A plurality of permanent magnets 62 are disposed in the slots 60. Some of the slots 60 may remain empty, but at least some of the slots 60 house permanent magnets 62. As shown, one permanent magnet 62 may be disposed in each of the slots 60. Each of the permanent magnets 62 may be a rare-earth magnet. For simplicity in the drawings, the magnets 62 are shown in only one of the pole portions 64 of the rotor 52 in FIG. 3. However, slots 60 and magnets 62 are disposed in identical arrangements at each of the eight pole portions. As shown in FIG. 4, at each pole portion 64, the permanent magnets 62 disposed in the slots 60 are arranged in a V-configuration and are symmetric to and at equal angles to a pole axis 66 in this embodiment. As shown, the rotor 52 is arranged as an 8-pole device. Embodiments of the rotor 52 may have two pole portions 64, four pole portions 64, six pole portions 64, eight pole portions 64, or another suitable quantity of pole portions 64. As shown, the pole portion 64 includes two layers of slots 60 filled with magnets 62 disposed near an outer periphery of the stator 50, wherein the layers are defined in relation to the outer periphery. Two layers are shown, but other quantities of layers may be employed. When the laminations are assembled onto the shaft 28, the slots 60 are aligned and are arranged parallel to the longitudinal axis A1. Magnets 62 may be inserted into some or all of the slots 60, and a subset of the plurality of slots 60 may be unfilled and thus may function as flux barriers. Other elements of the electric machine 18, e.g., end caps, shaft bearings, electrical connections, etc., are included but not shown.

The electrical windings 58 may be arranged in a distributed winding configuration to provide a revolving electrical field arrangement that provides a rotating magnetic field in the stator 50 by applying a three-phase alternating current, which can be supplied by the power inverter 26. The power inverter 26 may be integrated into the package of the stator 50. During operation, electro-magnetic forces that are induced in the electrical windings 58 introduce magnetic flux that acts upon the permanent magnets 62 embedded in the rotor 52, thus exerting a torque to cause the rotor 52 to rotate the rotor shaft 28 about the axis A1.

The permanent magnets 62 inserted into the slots 60 define the poles of each of the pole portions 64. Each of the pole portions 64 defines a direct or d-axis 70 and a quadrature or q-axis 72, wherein the d-axis 70 is aligned with the center of the magnetic pole, also referred to as a pole axis 66, and the q-axis 72 is orthogonal to the d-axis 70 and aligned with a mid-point of two magnetic poles of the rotor. The d-axis 70 indicates an orientation having the lowest inductance, and the q-axis 72 indicates an orientation having the highest inductance. As such, there is a d-axis 70 and a q-axis 72 associated with each of the pole portions 64.

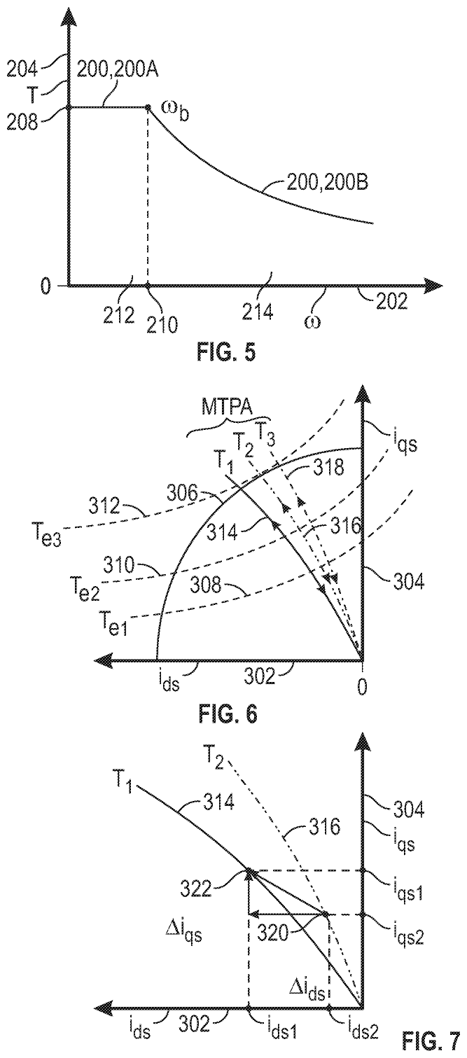

FIG. 5 is a plot 200 of rotational speed ω202 (also referred to as rotor speed) in revolutions per minute (rpm) of the electric machine 18 on the horizontal axis and electromagnetic torque output T 204 in Newton-meters (N-m) of the electric machine 18 on the vertical axis. As can be seen by portion 200A of the plot 200, the electric machine 18 is configured to provide a constant torque at rotor speeds from 0 rpm to a base speed 210 (also referred to as base speed ω_{b}) with a maximum torque of 208. The base rotor speed ω_{b} is a maximum rotor speed corresponding with constant torque operation of the interior permanent magnet motor at the nominal temperature of the interior permanent magnet motor. Operation of the electric machine 18 at rotational speeds of the rotor 52 greater than the base speed ω_{b} 210 provides a maximum torque less than the maximum torque 208, as can be seen by the portion 200B of plot 200. Operation at speeds from 0 rpm to the base speed ω_{b} 210 is referred to as the constant torque region 212. Operation at speeds greater than the base speed ω_{b} 210 up to the maximum speed of the electric machine is referred to as the constant power region 214. The most energy efficient operation of the electric machine 18 in the constant torque region 212 is according to a maximum torque per ampere (MTPA) trajectory shown in FIG. 6. The most energy efficient operation of the electric machine 18 in the constant power region 214 is according to a flux-weakening control strategy that shifts toward the maximum torque per volt (MTPV) trajectory 314C, 316C shown in FIG. 10. As used herein, energy efficient operation is operation that maximizes torque output of the electric machine 18 on a per amp basis or on a per volt basis to best utilize energy stored in the energy storage device 24.

FIG. 6 shows a plot of MTPA operation of the interior permanent magnet motor 18 with d-axis current 302 (also referred to as i_{ds}) of the stator 50 of the electric machine 18 on the horizontal axis and q-axis current 304 (also referred to as i_{qs}) on the vertical axis. An inverter current limit 306 is shown. Various curves for providing constant electromagnetic torque by the rotor 52 are shown as a first constant torque curve 308, a second constant torque curve 310, and a third constant torque curve 312, and depict respective constant electromagnetic torques increasing in order from a first electromagnetic torque Tₑ₁, a second electromagnetic torque Tₑ₂, and a third electromagnetic torque Tₑ₃.

The effect of the temperature of the permanent magnets 62 on the MTPA trajectory is illustrated by three different MTPA trajectories including MTPA trajectory 314 at a first temperature T1, MTPA trajectory 316 at a second temperature T2, and MTPA trajectory 318 at a third temperature T3, where the first temperature T1 is higher than the second temperature T2, and the second temperature T2 is higher than the third temperature T3. The arrowheads in both directions on each of the trajectories 314, 316, and 318 indicate that for any speed in the constant torque region 212, the most efficient control of the current of the electric machine 18 is a torque-speed operating point along the trajectory. FIG. 6 does not illustrate the effect of temperature on the most efficient control of the electric machine 18 at speeds above the base speed.

FIG. 7 is a close-up plot of the trajectories 314 and 316. The operating point for MTPA operation to provide a commanded torque when the temperature of the permanent magnets 62 is at temperature T2 is at point 320, corresponding with d-axis current i_{ds2} and q-axis current i_{qs2}. The operating point for MTPA operation to provide the same commanded torque when the temperature of the permanent magnets 62 is at temperature T1 is at point 322, corresponding with d-axis current i_{ds1} and q-axis current i_{qs1}. The difference Δi_{ds} between the corrected d-axis current (i_{ds_corr}) for higher temperature T1 and the d-axis current (i_{ds_uncorr}) that will be commanded if the controller 36 determines the current based on one presumed lower operating temperature T2 is:

Δi_{ds}=i_{ds_corr}−i_{ds_uncorr}.

Similarly, the difference Δi_{qs} between the corrected q-axis current (i_{qs_corr}) for higher temperature T1 and the q-axis current (i_{qs_uncorr}) that will be commanded if the controller 36 determines the current based on one presumed lower operating temperature T2 is:

Δi_{qs}=i_{qs corr}−i_{qs uncorr}.

If the controller 36 does not correct for these differences, and instead operates as if the temperature were T2 instead of the actual temperature T1, then the currents determined by the controller 36 will not result in the torque commanded by the controller 36. For example, if the controller 36 calculates d-axis and q-axis reference currents or accesses a lookup table of stored d-axis and q-axis reference currents derived from offline calibrations performed at a single reference temperature, such as the control temperature that the motor cooling system attempts to maintain, e.g., 90 degrees Celsius, then the commanded d-axis and q-axis currents will result in a torque different from that commanded leading to inefficiency in use of the stored energy in the energy storage device 24.

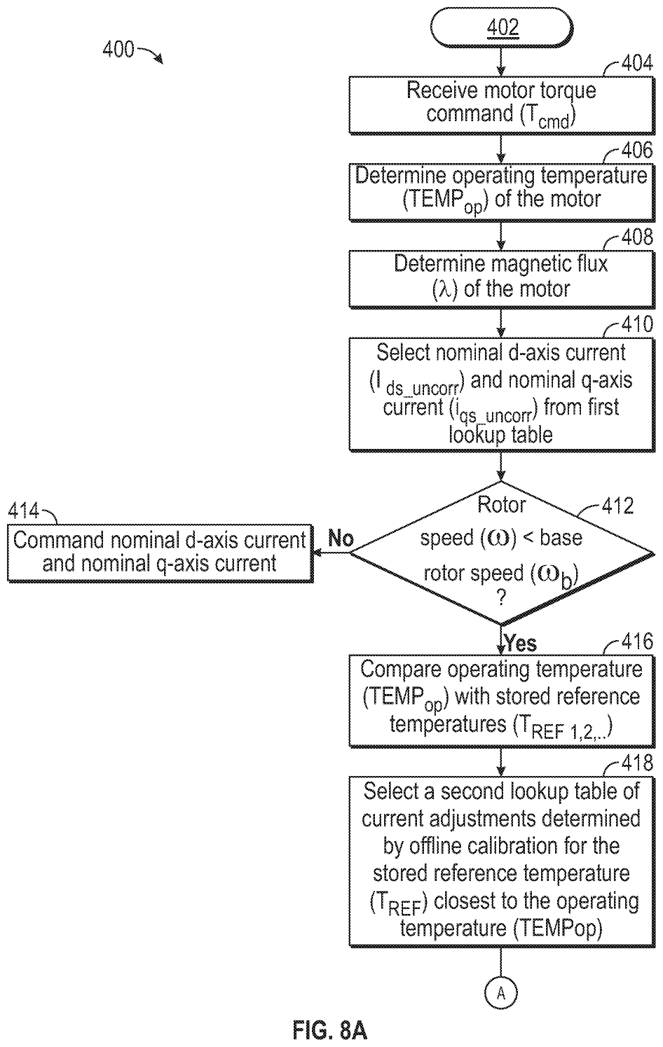

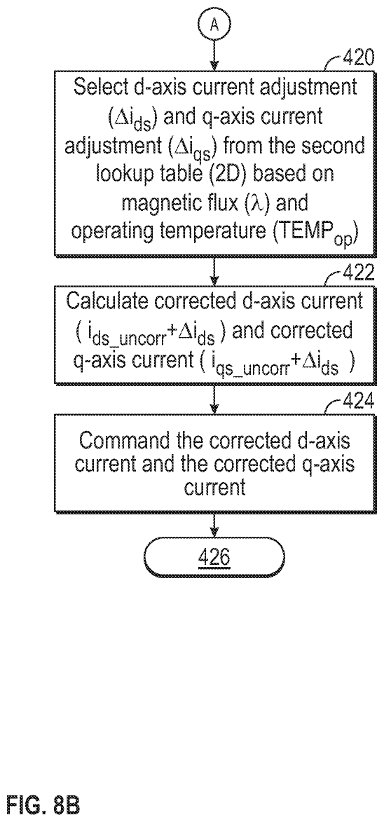

With reference to FIGS. 8A-8B, in order to provide commanded d-axis and q-axis currents that will achieve optimum energy efficiency under temperature variation of the permanent magnets 62, the controller 36 implements a method 400 of controlling the electric machine 18 that accounts for temperature variation of the permanent magnets 62 for operation in the constant torque region 212 of FIG. 5. At speeds above the base speed ω_{b} (e.g., operation in the constant power region 214), the effect of temperature on the resulting torque of the electric machine 18 is not as great, and accessing a lookup table of d-axis and q-axis currents for a single reference temperature may provide a sufficiently accurate torque output, saving the calibration effort of determining reference currents at various different operating temperatures for rotor speeds above the base speed ω_{b}.

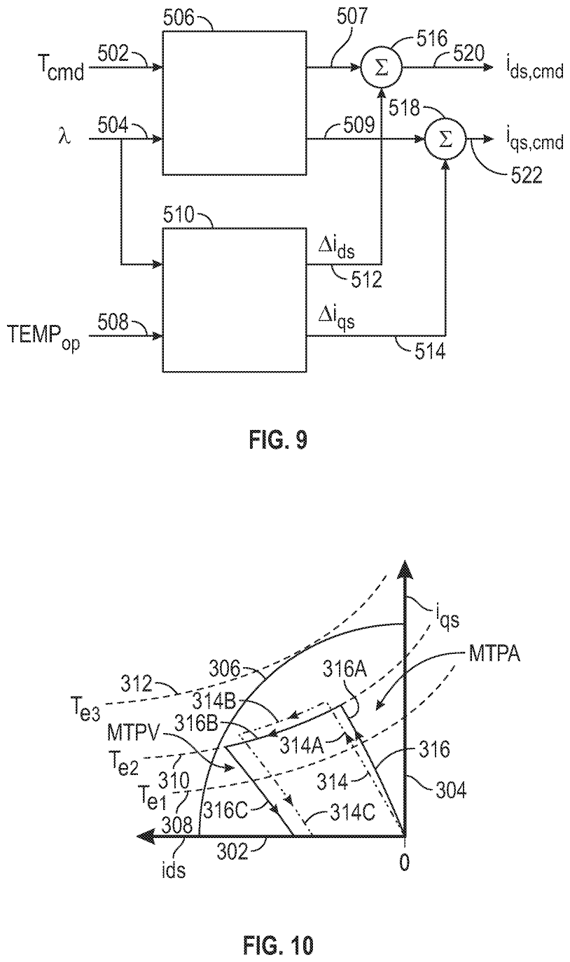

The method 400 begins at start 402, such as when the powertrain 10 receives a signal that the vehicle 12 has been powered on. In step 404, the controller 36 receives a motor torque command (T_{cmd}) indicated as signal 502 in FIG. 9. Next, in step 406, the controller 36 determines the operating temperature (TEMPₒₚ) of the electric machine 18. More specifically, the operating temperature TEMPₒₚ is the operating temperature of the permanent magnets 62. The operating temperature TEMPₒₚ may be estimated based on the temperature of cooling oil in a cooling system 19 of the interior permanent magnet motor 18 and/or the flow rate of the cooling oil and/or an operating d-axis current and an operating q-axis current and/or using one or more analytical lumped parameter models to estimate the temperature. The operating d-axis current and an operating q-axis current may be estimated based on the last-commanded currents (e.g., the commanded currents at which the interior permanent magnet motor 18 is currently operating). The temperature of the cooling oil of the interior permanent magnet motor 18 and the flow rate of the cooling oil may be determined from a temperature sensor 21 and a flow sensor 23, respectively, that may be disposed in the motor cooling system 19 shown in FIG. 1. Other sensors or analytical models or operating parameters may be used to estimate or directly measure the operating temperature TEMPₒₚ.

In step 408, the controller 36 may determine the magnetic flux λ of the interior permanent magnet motor 18, indicated as signal 504 in FIG. 9. The magnetic flux λ is based on the rotor speed of the interior permanent magnet motor 18 and a voltage level of the energy storage device 24 configured to power the interior permanent magnet motor 18.

In step 410, the controller 36 selects a nominal d-axis current (i_{ds_uncorr}) 507 and a nominal q-axis current (i_{qs_uncorr}) 509 stored in a first lookup table 506 (shown in FIG. 9) stored in the memory 40 of the controller 36. The nominal d-axis current i_{ds_uncorr} 507 and the nominal q-axis current i_{qs_uncorr} 509 correspond with a predetermined efficiency of the interior permanent magnet motor 18 at a nominal temperature of the interior permanent magnet motor 18 and are based on the motor torque command T_{cmd} 502 and the magnetic flux λ at the nominal temperature of the interior permanent magnet motor 18. Accordingly, the first lookup table 506 may be a two-dimensional (2D) table based on two variables: the motor torque command T_{cmd} 502 and the magnetic flux λ504. The predetermined efficiency may be the MTPA trajectory at the nominal temperature for certain rotor speeds as discussed herein, and the nominal temperature may be the presumed operating temperature of the electric machine 18 based on the motor cooling system 19, such as 90 degrees Celsius, as discussed herein.

To determine whether thermal adaptation will be employed in the method 400, the controller 36 determines in step 412 if the rotor speed ω_{b} of the interior permanent magnet motor 18 is less than or equal to the base rotor speed ω_{b}. If the rotor speed ω is not less than or equal to the base rotor speed ω_{b} (i.e., if the rotor speed ω is greater than the base rotor speed ω_{b}) (as indicated by “No” or “N”), then the method 400 moves to step 414, and commands the nominal d-axis current and the nominal q-axis current without determining a correction for the actual operating temperature of the magnet 62 versus the nominal temperature. The nominal d-axis current and the nominal q-axis current stored in the first lookup table 506 for rotor speeds w greater than the base rotor speed ω_{b} may be for maximum torque per ampere operation of the interior permanent magnet motor 18 based on the motor torque command T_{cmd} and the magnetic flux λ.

If in step 412 the controller 36 determines that rotor speed is less than or equal to the base rotor speed ω_{b} (as indicated by “yes” or “Y”), then the method 400 proceeds to make a thermal adjustment prior to commanding a d-axis current and a q-axis current to account for the effect of temperature on torque output of the electric machine 18. The method 400 proceeds to step 416, and compares the operating temperature TEMPₒₚ (indicated as 508 in FIG. 9) of the interior permanent magnet motor 18 with a plurality of stored reference temperatures each associated with a different one of a plurality of stored lookup tables, each of the plurality of stored lookup tables including d-axis current adjustments and q-axis current adjustments for constant torque operation of the interior permanent magnet motor 18 at a different one of the stored reference temperatures. In step 418, the stored lookup table (indicated at 510 in FIG. 9) associated with one of the stored reference temperatures closest to the operating temperature TEMPₒₚ of the interior permanent magnet motor 18 is selected, and then in step 420, the d-axis current adjustment Δi_{ds} and the q-axis current adjustment Δi_{qs} is selected from the stored lookup table 510. For example, the stored reference temperatures may be a series of temperatures from a minimum value to a maximum value at equal intervals, for example, −20 degrees Celsius to +120 degrees Celsius in increments of 20 degrees Celsius. By storing current adjustments for only some reference temperatures (e.g., reference temperatures in increments of 20 degrees Celsius), as opposed to storing current adjustments for every possible operating temperature, the calibration effort is reduced. The greater the number of stored lookup tables associated with a greater number of stored reference temperatures will provide a more refined and accurate thermal adjustment of the commanded d-axis and q-axis currents. Alternatively, in step 418, the controller 36 may select two of the stored lookup tables associated with the two stored references temperatures closest to the operating temperature and interpolate between the d-axis current adjustment Δi_{ds} and the q-axis current adjustment Δi_{qs} values stored in the stored in the two tables to determine the d-axis current adjustment Δi_{ds} and the q-axis current adjustment Δi_{qs}.

The flow diagram of FIG. 8A continues in FIG. 8B at A to step 420, in which the controller 36 selects a d-axis adjustment current (Δi_{ds}) 512 and a q-axis adjustment current (Δi_{qs}) 514 stored in the second lookup table 510 in the memory 40 of the controller 36, as illustrated in FIG. 9. The d-axis adjustment current Δi_{ds} and the q-axis adjustment current Δi_{qs} correspond with the predetermined efficiency of the interior permanent magnet motor 18 and are based at least on the magnetic flux λ504 and the operating temperature TEMPₒₚ 508 of the interior permanent magnet motor 18. Accordingly the table 510 may be a two-dimensional (2D) table with stored values based on two variables: magnetic flux λ504 and operating temperature TEMPₒₚ 508. The second lookup table 510 includes stored values based on offline calibration. For example, offline calibration may be conducted on a dynamometer using actual components identical to those of the powertrain 10 to determine the d-axis adjustment current and the q-axis adjustment current for various operating temperatures and at various magnetic flux values. The direction of the current vector may be calculated by the controller 36 based on the magnitudes of the d-axis current adjustment Δi_{ds} and the q-axis current adjustment Δi_{qs}.

In step 422, the controller 36 calculates a corrected d-axis current (i_{ds_corr}) and a corrected q-axis current (i_{qs_corr}), indicated at 516 and 518, respectively, wherein the corrected d-axis current i_{ds_corr} is a sum of the nominal d-axis current i_{ds_uncorr} 507 and the d-axis current adjustment Δi_{ds}, and the corrected q-axis current i_{qs_corr} is a sum of the nominal q-axis current i_{qs_uncorr} 509 and the q-axis current adjustment Δi_{qs}.

In step 424, the controller 36 commands i_{ds_cmd}, which is the corrected d-axis current i_{ds corr}, and also commands i_{qs cmd}, which is the corrected q-axis current i_{qs corr}, indicated as 520 and 522, respectively, in FIG. 9. Accordingly, the output torque actually provided by the electric machine 18 will be closer to the commanded torque due to the adjustment for the effect of temperature on the torque output of the electric machine 18. After step 424, the method 400 ends at step 426, and will begin again at step 404 when a subsequent motor torque command is received by the controller 36, and will repeat until the powertrain 10 is powered off, at which point the method 400 will end.

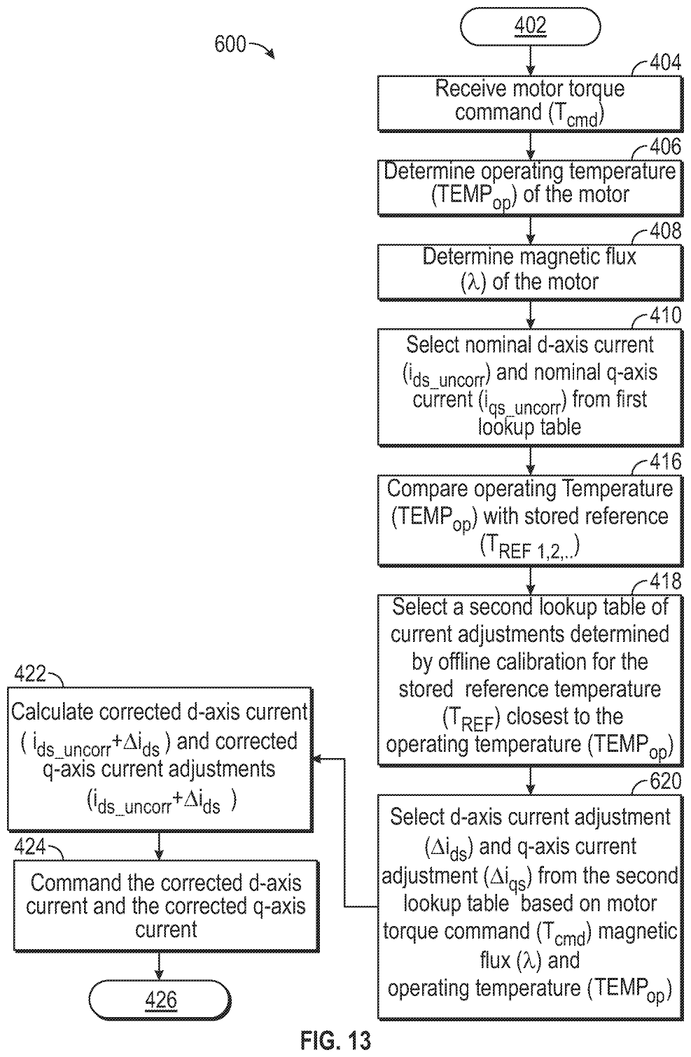

For greater torque accuracy and drive efficiency, control of the electric machine 18 may employ thermal adaptation for the entire operating speed range of the rotor 52 (i.e., for all rotational speeds of the rotor 52, not just speeds less than or equal to the base rotor speed ω_{b}). As discussed with respect to FIGS. 12 and 13, this will require greater calibration effort, as a three-dimensional rather than a two-dimensional lookup table of calibrated values is used, and because the direction of the current adjustment factors vary depending on the operating speed for speeds above the base speed ω_{b} of the rotor 52.

Referring to FIG. 10, the plot of d-axis current and q-axis current as well as the inverter current limit 306 and the constant electromagnetic torque curves 308, 310, and 312 are shown. The MTPA trajectory 314 at the higher first temperature T1, and the TPA trajectory 316 at the lower second temperature T2 are shown for all operating speeds. The portions of the trajectories for MTPA operation at rotor speeds at or below the base speed ω_{b} are shown as 314A, 316A, respectively, and are the same trajectories as shown in FIG. 6. At speeds above the base speed ω_{b}, assuming that it is desired to have a constant torque output at Tₑ₂ 310, the trajectory for temperature T2 proceeds along the constant torque line 310 at 316B and, as speed continues to increase, proceeds along the MTPV trajectory 316C. For the most efficient operation at the higher temperature T1, the d-axis current i_{d1} and q-axis current i_{q1} to provide a commanded torque should be along the MTPA trajectory 314A at speeds below the base speed ω_{b}, then along the portion 314B of a constant torque curve, and then along the MTPV trajectory 314C.

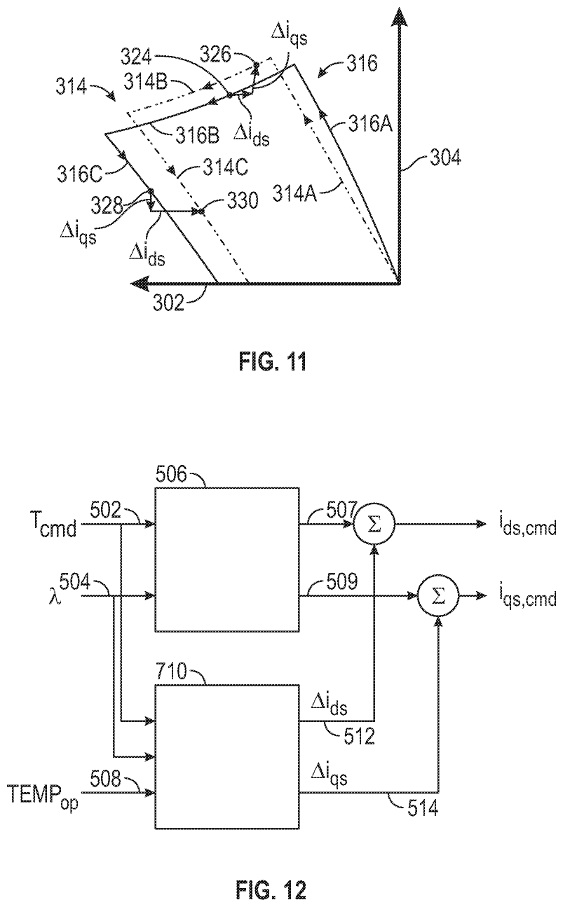

FIG. 11 is a close-up plot of the trajectories 314 and 316. It is clear from FIG. 11 that the direction of the d-axis current adjustment Δi_{ds} and the q-axis current adjustment Δi_{qs} varies with speed above the base speed ω_{b}. For example, in the MTPA portions of the trajectories 314A, 316A, the higher temperature trajectory 314A is to the left of the lower temperature trajectory 316A. Operation at MTPA to achieve the same commanded torque is as described with respect to points 320 and 322 in FIG. 7, with the d-axis current adjustment Δi_{ds} being an increase in current, and the q-axis current adjustment Δi_{qs} being an increase in current. At higher speeds, the portion 314B of the higher temperature trajectory is also above the portion 316B of the lower temperature trajectory. The operating point to provide the same commanded torque as at operating temperature T2 as point 324 when the temperature of the permanent magnets 62 is at temperature T1 is shifted to point 326. The d-axis current adjustment Δi_{ds} is a decrease in d-axis current, and the q-axis current adjustment Δi_{qs} is an increase in q-axis current. At even higher speeds, in the constant power region 214, the higher temperature trajectory 314C is to the right of the lower temperature trajectory 316C, which is the opposite as the relative placements along the MTPA portions of the trajectories 314A, 316A. The operating point for MTPV operation to provide a commanded torque when the temperature of the permanent magnets 62 is at temperature T2 is at point 328. The operating point for MTPV operation to provide the same commanded torque when the temperature of the permanent magnets 62 is at temperature T1 is at point 330. The d-axis current adjustment Δi_{ds} is a decrease in current, and the q-axis current adjustment Δi_{qs} is also a decrease in current.

To provide thermal adaptation for the entire operating speed range of the rotor 52, a method 600 set forth in FIG. 13 is executed by the controller 36. The method 600 has many of the same steps as described with respect to the method 400, and these steps are referred to with like reference numbers. However, as can be seen in the schematic depiction of the method 600 in FIG. 12, the second lookup table 510 is replaced with a second lookup table 710. The second lookup table 710 is a three-dimensional (3-D) lookup table, as the d-axis and q-axis current adjustments Δi_{ds} 512 and Δi_{qs} 514 are calibrated offline and stored in the plurality of 3-D reference tables for different reference temperatures, and according to three variables, including the motor torque command (T_{cmd}) 502 in addition to operating temperature TEMPₒₚ 508 and the magnetic flux λ504. By including the motor torque command (T_{cmd}) 502, the appropriate portion (leg 314A, 314B, or 314C and leg 316A, 316B, or 316C) of the trajectories 314 and 316 is accounted for, which allows the direction of change (increase or decrease) for both the d-axis and q-axis current adjustments Δi_{ds} and Δi_{qs} to be correctly reflected in the selected values.

Referring to FIG. 13, the method 600 begins at start 402, and proceeds with steps 404, 406, 408, and 410 as described with respect to method 400. However, following step 410, the method 600 proceeds directly to step 416, and steps 412 and 414 are omitted. This is because current adjustments to account for the effect of temperature are implemented for all rotor speeds. Steps 416 and 418 are carried out as described with respect to method 400. Following step 418, instead of step 420, the controller 36 carries out step 620, and the d-axis current adjustment Δi_{ds} and the q-axis current adjustment Δi_{qs} are selected from the stored second lookup table 710, the 3-D lookup table described with respect to FIG. 12. Accordingly, d-axis current adjustment Δi_{ds} and the q-axis current adjustment Δi_{qs} are selected from the reference table for the stored reference temperature closest to the operating temperature TEMPₒₚ, which includes d-axis current adjustment Δi_{ds} and q-axis current adjustment Δi_{qs} values and directions determined offline based on the motor torque command (T_{cmd}) 502, operating temperature TEMPₒₚ 508, and the magnetic flux λ504.

Accordingly, the control methods disclosed herein account for the effect of operating temperature of the permanent magnets 62 of the electric machine 18 on the d-axis and q-axis currents associated with a commanded torque. More accurate determination of the d-axis and q-axis currents enables efficient operation of the electric machine 18. By calibrating the current adjustments offline and storing the values in 2D and 3D lookup tables associated with different reference temperatures, the online calculation effort is minimized. The calibration effort can be further minimized by providing current adjustments only in the constant torque operating region. Alternatively, optimal efficiency over the entire range of operating speeds can be achieved by providing current adjustments for all operating speeds. Additionally, by selecting the temperature increments for the stored lookup tables to be accessed, the resulting accuracy of the commanded d-axis and q-axis currents and associated efficiency of the electric machine operation, as well as the overall offline calibration effort is determined.

While the best modes for carrying out the disclosure have been described in detail, those familiar with the art to which this disclosure relates will recognize various alternative designs and embodiments for practicing the disclosure within the scope of the appended claims.

What is claimed is:

1. A method of controlling an interior permanent magnet motor, the method comprising:
receiving a motor torque command;
selecting, via a controller, a nominal d-axis current and a nominal q-axis current from a first lookup table stored in a memory of the controller, the nominal d-axis current and the nominal q-axis current corresponding with a predetermined efficiency of the interior permanent magnet motor at a nominal temperature of the interior permanent magnet motor and based on the motor torque command and a magnetic flux at the nominal temperature of the interior permanent magnet motor;
selecting, via the controller, a d-axis adjustment current and a q-axis adjustment current from a second lookup table stored in the memory of the controller, the d-axis adjustment current and the q-axis adjustment current corresponding with the predetermined efficiency of the interior permanent magnet motor and based at least on the magnetic flux and an operating temperature of the interior permanent magnet motor; and
commanding, via the controller, a corrected d-axis current and a corrected q-axis current; wherein the corrected d-axis current is a sum of the nominal d-axis current and the d-axis adjustment current, and the corrected q-axis current is a sum of the nominal q-axis current and the q-axis adjustment current.

2. The method of claim 1, further comprising:
determining if a rotor speed of the interior permanent magnet motor is less than or equal to a base rotor speed;
wherein selecting the d-axis adjustment current and the q-axis adjustment current and commanding the corrected d-axis current and the corrected q-axis current is only if the rotor speed is less than or equal to the base rotor speed; and
if the rotor speed is greater than the base rotor speed, commanding the nominal d-axis current and the nominal q-axis current.

3. The method of claim 2, wherein, if the rotor speed is greater than the base rotor speed, the nominal d-axis current and the nominal q-axis current are for maximum torque per ampere operation of the interior permanent magnet motor; and the method further comprising:
commanding the nominal d-axis current and the nominal q-axis current for maximum torque per ampere operation of the interior permanent magnet motor based on the motor torque command and the magnetic flux command.

4. The method of claim 2, wherein the base rotor speed is a maximum rotor speed corresponding with constant torque operation of the interior permanent magnet motor at the nominal temperature of the interior permanent magnet motor.

5. The method of claim 1, wherein the d-axis adjustment current and the q-axis adjustment current are further based on the motor torque command; and the method further comprising:
selecting the d-axis adjustment current and the q-axis adjustment current and commanding the corrected d-axis current and the corrected q-axis current is regardless of rotor speed.

6. The method of claim 1, further comprising:
comparing the operating temperature of the interior permanent magnet motor with a plurality of stored reference temperatures each associated with a different one of a plurality of stored lookup tables, each of the plurality of stored lookup tables including d-axis adjustment currents and q-axis adjustment currents for constant torque operation of the interior permanent magnet motor at a different one of the stored reference temperatures; and
wherein the d-axis adjustment current and the q-axis adjustment current is selected from one of the stored lookup tables associated with one of the stored reference temperatures closest to the operating temperature of the interior permanent magnet motor or is determined by interpolation between d-axis adjustment currents and q-axis adjustment currents from two of the stored lookup tables associated with two of the stored reference temperatures closest to the operating temperature.

7. The method of claim 6, wherein the stored reference temperatures are a series of temperatures from a minimum to a maximum value at equal intervals.

8. The method of claim 1, further comprising:
determining the operating temperature of the interior permanent magnet motor by estimating the operating temperature based on any one or more of temperature of cooling oil of the interior permanent magnet motor, flow rate of the cooling oil, or an operating d-axis current and an operating q-axis current, or an analytical lumped parameter model.

9. The method of claim 1, further comprising:
determining the operating temperature of the interior permanent magnet motor by at least one sensor operatively connected to the interior permanent magnet motor.

10. The method of claim 1, further comprising:
determining the magnetic flux of the interior permanent magnet motor based on a rotor speed of the interior permanent magnet motor and a voltage level of a battery configured to power the interior permanent magnet motor.

11. The method of claim 10, wherein the second lookup table includes stored values based on offline calibration.

12. The method of claim 11, wherein a direction of change in current is determined from the stored values of the d-axis adjustment current and the q-axis adjustment current.

13. A powertrain comprising:
an interior permanent magnet motor;
an energy storage device operatively connected to the interior permanent magnet motor and configured to power the interior permanent magnet motor to function as a motor;
a controller operatively connected to the energy storage device and to the interior permanent magnet motor; wherein the controller is configured to receive a motor torque command, and includes a processor and a memory with instructions executable by the processor, wherein execution of the instructions by the processor causes the processor to:
select a nominal d-axis current and a nominal q-axis current from a first lookup table stored in the memory of the controller, the nominal d-axis current and the nominal q-axis current corresponding with a predetermined efficiency of the interior permanent magnet motor at a nominal temperature of the interior permanent magnet motor and based on the motor torque command and a magnetic flux of the interior permanent magnet motor;
select a d-axis adjustment current and a q-axis adjustment current from a second lookup table stored in the memory of the controller, the d-axis adjustment current and the q-axis adjustment current corresponding with the predetermined efficiency of the interior permanent magnet motor and based at least on the magnetic flux and an operating temperature of the interior permanent magnet motor; and
command a corrected d-axis current and a corrected q-axis current; wherein the corrected d-axis current is a sum of the nominal d-axis current and the d-axis adjustment current, and the corrected q-axis current is a sum of the nominal q-axis current and the q-axis adjustment current.

14. The powertrain of claim 13, wherein the powertrain is installed on a hybrid vehicle or an all-electric vehicle.

15. The powertrain of claim 13, wherein execution of the instructions by the processor further causes the processor to:
determine if a rotor speed of the interior permanent magnet motor is less than or equal to a base rotor speed;
wherein the processor selects the d-axis adjustment current and the q-axis adjustment current and commands the corrected d-axis current and the corrected q-axis current only if the rotor speed is less than or equal to the base rotor speed; and
if the rotor speed is greater than the base rotor speed, the processor commands the nominal d-axis current and the nominal q-axis current.

16. The powertrain of claim 15, wherein, if the rotor speed is greater than the base rotor speed, the nominal d-axis current and the nominal q-axis current are for maximum torque per ampere operation of the interior permanent magnet motor; and
wherein execution of the instructions by the processor further causes the processor to:
command the nominal d-axis current and the nominal q-axis current for maximum torque per ampere operation of the interior permanent magnet motor based on the motor torque command and the magnetic flux.

17. The powertrain of claim 13, wherein:
the d-axis adjustment current and the q-axis adjustment current are further based on the motor torque command; and
the processor selects the d-axis adjustment current and the q-axis adjustment current and commands the corrected d-axis current and the corrected q-axis current regardless of rotor speed.

18. The powertrain of claim 13, wherein execution of the instructions by the processor further causes the processor to:
compare the operating temperature of the interior permanent magnet motor with a plurality of stored reference temperatures each associated with a different one of a plurality of stored lookup tables, each of the plurality of stored lookup tables including d-axis adjustment currents and q-axis adjustment currents for constant torque operation of the interior permanent magnet motor at a different one of the stored reference temperatures;
select one of the stored lookup tables associated with one of the stored reference temperatures closest to the operating temperature of the interior permanent magnet motor and select the d-axis adjustment current and the q-axis adjustment current stored in the one of the stored lookup tables selected, or interpolate between d-axis adjustment currents and q-axis adjustment currents from two of the stored lookup tables associated with two of the stored reference temperatures closest to the operating temperature.

19. The powertrain of claim 13, wherein execution of the instructions by the processor further causes the processor to:
determine the operating temperature of the interior permanent magnet motor by estimating the operating temperature based on any one or more of temperature of cooling oil of the interior permanent magnet motor, flow rate of the cooling oil, an operating d-axis current and an operating q-axis current, or an analytical lumped parameter model.

20. The powertrain of claim 13, wherein:
the d-axis adjustment current and the q-axis adjustment current stored in a second lockup table are based on offline calibration.
